(19) United States
(12) Patent Application Publication
(10) Pub. No.: US 2023/0413840 A1
(43) Pub. Date: Dec. 28, 2023

(54) PROCESS FOR MAKING PROTEIN ENRICHED BUTTER

(71) Applicant: Select Milk Producers, Inc., Dallas, TX (US)

(72) Inventors: Ronald I. THOMPSON, Muskegon, MI (US); Steven COOPER, South Haven, MI (US); Shay BRAUN, Little Elm, TX (US); Aaron MACHA, La Crosse, WI (US)

(21) Appl. No.: 18/212,472

(22) Filed: Jun. 21, 2023

Related U.S. Application Data
(60) Provisional application No. 63/366,793, filed on Jun. 22, 2022.

(51) Int. Cl. A23C 15/06; A23C 15/12; A23D 7/04; A23D 7/00

(52) U.S. Cl. CPC A23C 15/06; A23D 7/001; A23D 7/04; A23C 15/12

(57) ABSTRACT

The invention relates to a process for making a protein enriched butter, margarine or spread and the product made by the process.

### FIELD OF THE INVENTION

This invention relates to a process for making protein enriched butter, margarine or spread. The process comprises adding protein to the cream before or after pasteurizing the cream, then churning the protein-enriched cream, removing the buttermilk and forming the butter into desired form. The process in another embodiment comprises separating cream from raw milk, churning the cream to produce butter (also referred to as butter solids) and buttermilk, removing the buttermilk from the butter, mixing the butter and protein and forming the butter with the protein into desired form.

### BACKGROUND OF THE INVENTION

In recent years, there has been an increased interest in protein enriched foods. High protein diets are promoted for weight loss and health benefits. People trying to build muscle mass and decrease body fat have particular interest in high protein diets. In addition to focusing on eating meat, fish, poultry, eggs, and cheese, these diets promote reducing carbohydrate intake.

Consumers focused on increasing protein intake can add protein to their food and/or to buy food that is already protein enriched from the base amount naturally occurring in the food. This interest in increasing protein in diets has generated an industry dedicated to adding protein to certain foods (protein enriched foods). These foods, such as snack bars, smoothie mixes, and oatmeal, are sold already enriched with protein.

Consumers focused on high protein levels include butter, margarine and spreads in their diets. Some of these consumers add protein to these foods before eating. By increasing the amount of protein in these foods, they will be more desirable to these consumers. Currently there are no protein enriched butters, margarines or spreads on the market.

### SUMMARY OF THE INVENTION

This invention provides a process for making protein enriched butter and the product produced by this process. It is an object of the invention to provide a process for making protein enriched butter by separating cream from raw milk, pasteurizing the cream, adding protein to the cream, churning the cream with the protein to produce butter and buttermilk, removing the buttermilk from the butter, and forming the butter into desired form.

This invention includes a process for making protein enriched butter by separating cream from raw milk, pasteurizing the cream, churning the cream to produce butter and buttermilk, adding protein to the cream during the churning step, removing the buttermilk from the butter, and forming the butter into desired form.

This invention also includes a process for making protein enriched butter by separating cream from raw milk, pasteurizing the cream, churning the cream to produce butter and buttermilk, removing the buttermilk from the butter, mixing the butter and protein, and forming the butter with the protein into desired form.

This invention also includes a process for making protein enriched butter by separating cream from raw milk, churning the cream to produce butter and buttermilk, removing the buttermilk from the butter, mixing the butter and protein, and forming the butter with the protein into desired form.

Each embodiment of the invention which uses dairy components may include pasteurization or exclude pasteurization.

An embodiment of the invention is a process for making protein enriched margarine by preparing oil, fat or a combination thereof to remove unnecessary free fatty acids, adding protein to the oil, fat or combination thereof, and hydrogenating the oil, fat or combination thereof.

An embodiment of the invention is a process for making protein enriched margarine by adding protein to oil, fat or a combination thereof to create a mixture, removing unnecessary free fatty acids from the mixture, and hydrogenating the oil, fat or combination thereof in the mixture thereof.

An embodiment of the invention is a process for making protein enriched margarine or spread by preparing oil, fat or a combination thereof to remove unnecessary free fatty acids, hydrogenating the oil, fat or combination thereof, and adding protein to the hydrogenated oil, fat or combination thereof.

The protein in this invention may be a milk protein, a milk protein concentrate, a milk protein isolate, caseinate, whey protein, a plant protein, an animal protein, liquid concentrated protein or a combination thereof, preferably a milk protein concentrate. Milk protein concentrate (“MPC”) may be any concentrated milk product containing 40-90% milk protein, preferably 70%-90% milk protein. Milk protein isolate (“MPI”) may be any concentrated milk product containing 90% or more milk protein. Whey protein (also called whey protein concentrate “WPC”) may be any concentrated whey product containing 30-90% whey protein, preferably 40-90%, more preferably 70-90% whey protein. Whey protein isolate (“WPI”) may be any concentrated whey product containing 90% or more whey protein. WPC, WPI, MPC or MPI may be referred to with a number immediately following WPC, WPI, MPC or MPI (e.g. WPC80), where the number reflects the percentage of protein in the concentrate or isolate. Liquid concentrated protein may be any liquid concentrated protein, preferably concentrated WPI, concentrated WPC, condensed WPI, condensed WPC, or a concentration thereof.

### BRIEF DESCRIPTION OF THE DRAWING

The invention will be better understood by reference to the following detailed description of an embodiment when read in conjunction with the included drawing.

FIG. 1 is a flow diagram representing one embodiment of the steps involved in the process for making protein enriched butter.

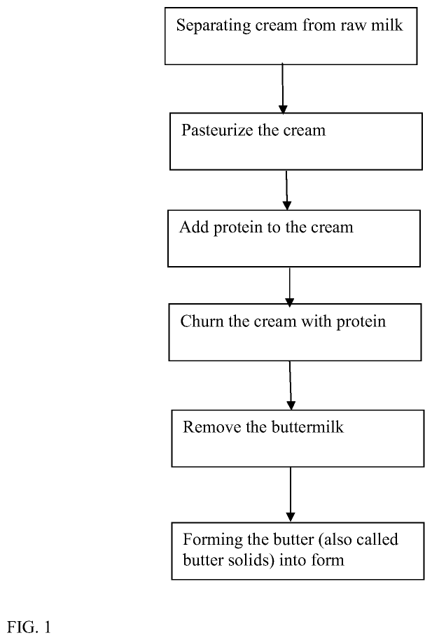

FIG. 2 is a flow diagram representing an embodiment of the steps involved in the process for making protein enriched butter.

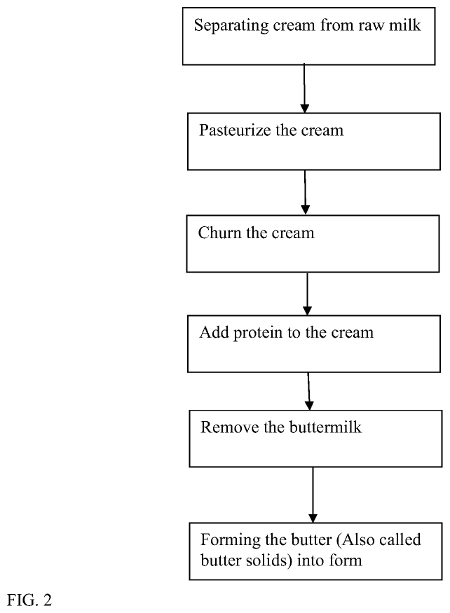

FIG. 3 is a flow diagram representing another embodiment of the steps involved in the process for making protein enriched butter.

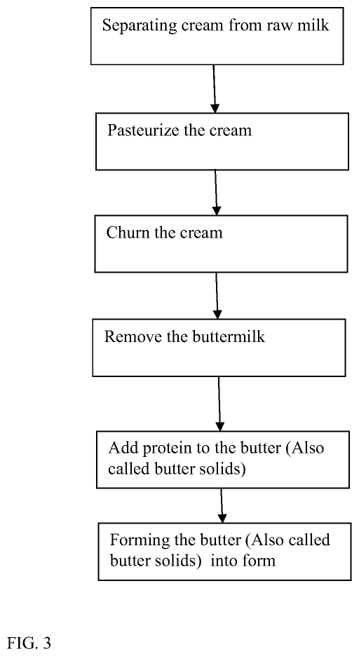

FIG. 4 is a flow diagram representing an embodiment of the steps involved in the process for making protein enriched margarine or spread.

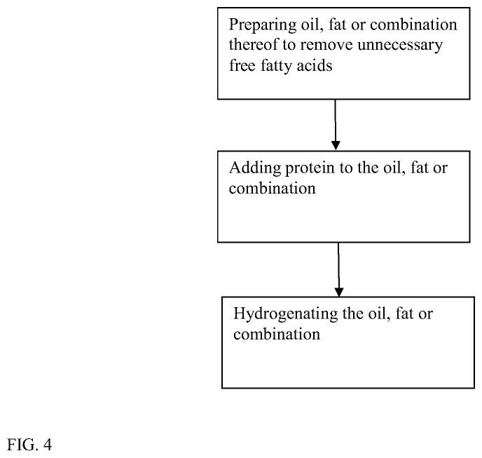

FIG. 5 is a flow diagram representing an embodiment of the steps involved in the process for making protein enriched margarine or spread.

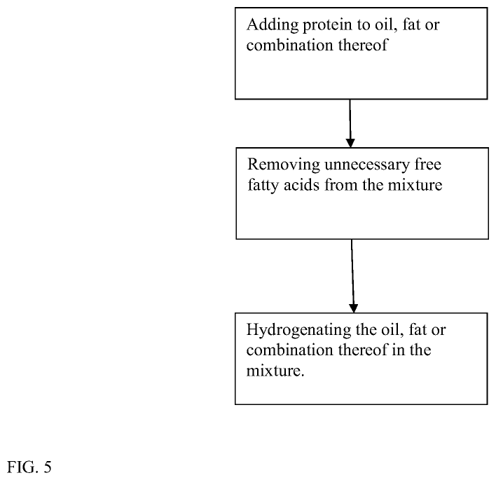

FIG. 6 is a flow diagram representing an embodiment of the steps involved in the process for making protein enriched margarine or spread.

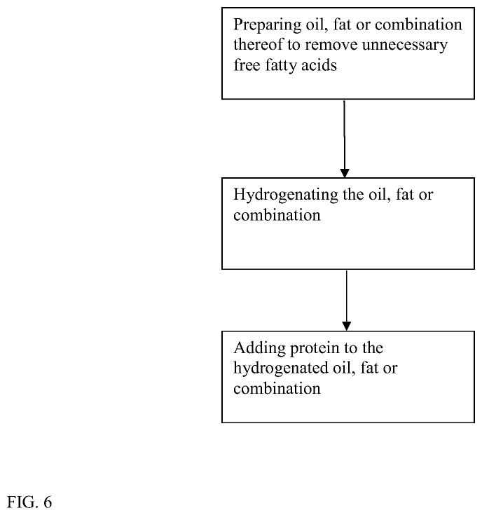

FIG. 7 is a flow diagram representing one embodiment of the steps involved in the process for making protein enriched butter.

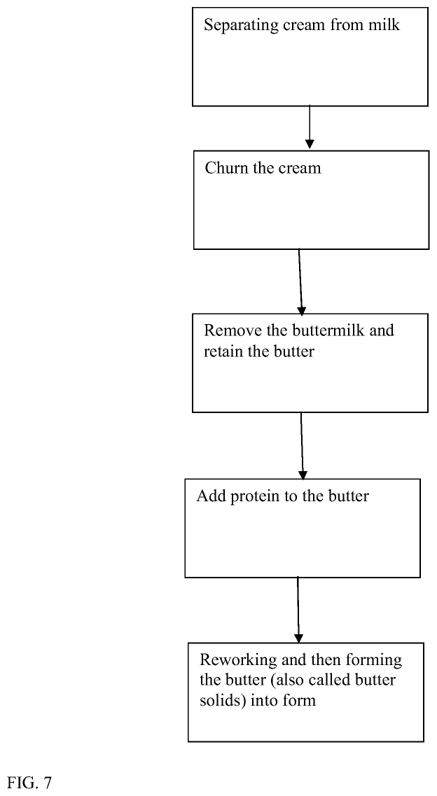

### DETAILED DESCRIPTION OF INVENTION

As used herein the term “milk” includes milk from animal sources, including but not limited to human, cow, sheep, goat, buffalo, camel, llama, mare and deer. Milk may be organic, non-organic, lactose-free or lactose-containing.

All percentages expressed herein are weight percentages (wt %), unless otherwise stated.

As used herein the term “lactose-free milk” is a milk in which the original lactose content in the milk has been converted to glucose and galactose by addition of the lactase enzyme, so that there is no more than about 1%, preferably no more than 0.5%, preferably no more than 0.10%, and preferably no more than 0.010% lactose present in the milk.

As used herein the term “reworker” means a homogenizer for the processing and packaging of butter, preferably cold stored butter, preferably with temperatures as low as minus 4 C, and may process butter in up to 25 kg blocks, and preferably from 800 kg to 10 tons per hour, for example the Rothenburg Reworker by Rothenburg GmbH. Reworkers are used to improve the quality of butter by providing fine water dispersion in the butter, resulting in an increased shelf life of the homogenized and packed butter. The process of reworking may also be termed mixing or homogenizing.

The butter, margarine, and spread produced by the process described may also be fortified with a mineral source, a carbohydrate source or a mixture therefore (“fortifying sources”). Examples of these sources include but are not limited to sources of calcium, vitamin D, salt, natural sweeteners, artificial sweeteners, fiber sources and combinations thereof.

Natural and artificial sweeteners such as cane sugar, beet sugar, high fructose corn syrup, saccharine, aspartame, asulfame K, sucralose and their combination, as well as others, may be incorporated to enhance the organoleptic and sweetness quality of the compositions. Various fiber sources may be included in the compositions of the present invention. These sources may be selected from such materials as oat fiber, soy fiber, guar gum, pectin, soy polysaccharides, gum arabic, hydrolyzed fibers and the like. Cellulose, hemicellulose, hydrocolloids, methylcellulose, carboxymethyl cellulose and the like are contemplated. Also useful are fructo-oligosaccharides.

Various non-nutritive components can be included in the products. For example, fillers, coloring agents, flavors, emulsifiers and the like are useful. Other nutritionally valuable, but non-essential components can be added, including choline, taurine, L-carnitine and the like. Combinations of these non-nutritive and non-essential components are contemplated. Various nutraceuticals and phytochemicals can be incorporated into the compositions for their intended function.

The processes include adding fortifying sources, non-nutritive components, non-essential components and combinations thereof (collectively referred to as “additives”). The additives may be added to the milk, cream, pasteurized cream, butter, oil, fat, hydrogenated oils, hydrogenated fat, and/or combinations thereof before and/or after the protein has been added.

It is contemplated that the cream may be heated before or after pasteurization to a temperature of around 100° F., or at least around 100° F. The cream may then be tempered for churning to about 45° F. to about 55° F., preferably at about 50° F.

The invention also encompasses the product produced by any of the process embodiments described herein. Protein enriched butter produced by the described processes may have about 1 to about 4% protein, preferably 2-3.8%, more preferably 3-3.8% protein. Protein enriched margarine produced by the described processes may have about 1 to about 4% protein, preferably 2% protein. Protein enriched spread produced by the described processes may have about 1 to about 5% protein, preferably 2.5% protein.

In one embodiment, a process for making protein enriched butter comprises the steps of separating cream from raw milk, pasteurizing the cream, adding protein to the cream, churning the cream with the protein to produce butter and buttermilk, removing the buttermilk from the butter, and forming the butter into desired form.

In an embodiment, a process for making protein enriched butter comprises the steps of separating cream from raw milk, pasteurizing the cream, churning the cream to produce butter and buttermilk, adding protein to the cream during the churning step, removing the buttermilk from the butter, and forming the butter into desired form.

One embodiment of the invention utilizes whey protein concentrate, preferably having 40-90%, more preferably having 70-90%, most preferably having 80-90% protein. The whey protein concentrate may be added to the mixer (also called a reworker) with the butter before being formed or reformed into the desired shape. It may be preferable to target 0.25-0.5 g protein/14 g serving of the finished product. It may be preferably to target 2-3.8%, more preferably 3-3.8%, protein total in the finished product.

Clauses of the Invention

Clause 1. A process for making protein enriched butter comprising the steps of
separating cream from raw milk,
pasteurizing the cream,
adding protein to the cream,
churning the cream with the protein to produce butter solids and buttermilk,
removing the buttermilk from the butter solids, and
forming the butter solids into desired form.

Clause 2. A process for making protein enriched butter comprising the steps of
separating cream from raw milk,
pasteurizing the cream,
churning the cream to produce butter solids and buttermilk,
adding protein to the cream during the churning step,
removing the buttermilk from the butter solids, and
forming the butter solids into desired form.

Clause 3. A process for making protein enriched butter comprising the steps of
separating cream from raw milk,
pasteurizing the cream,
churning the cream to produce butter solids and buttermilk,
removing the buttermilk from the butter solids,
mixing the butter solids and protein, and
forming the butter solids with the protein into desired form.

Clause 4. The process according to any of clauses 1, 2 or 3, wherein the protein is a milk protein, a milk protein concentrate, a milk protein isolate, a plant protein, an animal protein or a combination thereof.

Clause 5. The process according to any of clauses 1-4 wherein the process is performed in order as listed in the claim.

Clause 6. The process according to any of clauses 1-4 wherein the pasteurizing is before the separating.

Clause 7. The process according to any of clauses 1-4 wherein the adding protein is before the pasteurizing.

Clause 8. A process for making protein enriched margarine or spread comprising the steps of
preparing oil, fat or a combination thereof to remove unnecessary free fatty acids,
adding protein to the oil, fat or combination thereof, and
hydrogenating the oil, fat or combination thereof.

Clause 9. A process for making protein enriched margarine or spread comprising the steps of
adding protein to oil, fat or a combination thereof to create a mixture,
removing unnecessary free fatty acids from the mixture, and
hydrogenating the oil, fat or combination thereof in the mixture.

Clause 10. A process for making protein enriched margarine or spread comprising the steps of
preparing oil, fat or a combination thereof to remove unnecessary free fatty acids,
hydrogenating the oil, fat or combination thereof, and
adding protein to the hydrogenated oil, fat or combination thereof.

Clause 11. The process according to any of clauses 1-10 further comprising adding one or more additives to one or more of the milk, cream, pasteurized cream, butter solids, oil, fat, hydrogenated oils, hydrogenated fat, and/or combinations thereof before and/or after the protein has been added.

Clause 12. A protein enriched butter produced by the process according to any of clauses 1-7 or 11.

Clause 13. A protein enriched margarine or spread produced by the process according to any of clauses 8-11.

### Example 1

Cream was separated from raw milk and was pumped at 42° F. The cream was beaten and butter was removed from the buttermilk at 65° F. Whey protein concentrate was mixed with the butter. The finished product of whey protein concentrate and butter was tasted after mixing (“Mouthfeel #1”). Then the finished product was stored at 39° F. overnight and tasted again the next day (“Mouthfeel #2”). The finished product was then tasted after overnight storage at 39° F. and then warmed to about 64° F. (“Mouthfeel #3). The following Table reflects the results:

| | | Protein Powder in | Added | | | | |
|---|---|---|---|---|---|---|---|
| Trial | Protein source | finished product | protein* | Process | Mouthfeel #1 | Mouthfeel #2 | Mouthfeel #3 |
| 1 | WPC80 | 4.95% | 4.00% | Powder | Powdery | Powdery | Distinctly |
| | | | | added to | | | powdery |
| | | | | churned | | | and |
| | | | | butter | | | mouth |
| | | | | using a | | | drying. |
| | | | | Hobart | | | |
| | | | | mixer. | | | |
| 2 | WPC80 | 3.72% | 3.00% | Powder | Powdery | Smooth, | Powdery |
| | | | | added to | | similar to | |
| | | | | churned | | control | |
| | | | | butter | | butter. | |
| | | | | using a | | | |
| | | | | Hobart | | | |
| | | | | mixer. | | | |
| 3 | WPC80 | 3.72% | 3.00% | Taking | Powdery, | Powdery, | Distinctly |
| | | | | 20% of | with a | with a | powdery. |
| | | | | butter and | few small | few small | |
| | | | | mixing | lumps in | lumps in | |
| | | | | the | butter | butter | |
| | | | | powder. | | | |
| | | | | Then | | | |
| | | | | mixing | | | |
| | | | | that | | | |
| | | | | mixture | | | |
| | | | | into the | | | |
| | | | | remaining | | | |
| | | | | 80% of | | | |
| | | | | butter. | | | |
| 4 | WPI90 | 3.32% | 3.00% | Taking | Powdery, | Powdery, | Powdery, |
| | | | | 20% of | with a | with very | with very |
| | | | | butter and | few small | distinctly | distinct |
| | | | | mixing | lumps in | lumps in | lumps in |
| | | | | the | butter | butter | butter |
| | | | | powder. | | | |
| | | | | Then | | | |
| | | | | mixing | | | |
| | | | | that | | | |
| | | | | mixture | | | |
| | | | | into the | | | |
| | | | | remaining | | | |
| | | | | 80% of | | | |
| | | | | butter. | | | |

*Theoretical protein content in the finished product, which is the protein powder in the finished product multiplied by the percent protein in the protein source, for example for trial 1, 4.95 × 80% = 4.00.

Given these results, without being limited to mechanism, the melting of a portion of the butter to incorporate the protein powder (Trials 3 and 4) results in lumps, which (without limitation as to the mechanism) may be due to the free water clumping of the powder and preventing the mixing with the liquid butter and the rest of the butter. The lumps were more evident the following day. Trial 2 was successful because it was very smooth after the refrigeration, despite the powdery sensation returning after the butter was warmed.

In certain embodiments, the protein powder may be added to butter with a butterfat content higher than 80%, resulting in butter that meets regulations after adding the powder. Cooking trials of some to the finished products in Example 1 were favorable.

### Example 2

Commercially produced salted butter produced in 25 kg blocks, cooled to approximately 40° F., and stored until use at 40° F. Eight (8) blocks were added to the butter reworker, one at a time, and protein (Trial 1a—720 g WPC80, Trial 1b—630 g WPI90, Trial 2a—850 g WPI90, Trial 3a and 3b—1,000 g WPC80) was added to the butter reworker. The butter and protein was blended into a homogeneous mixture using the butter reworker with pin mixer.

| | | Protein Powder in | | | | |
|---|---|---|---|---|---|---|
| Trial | Protein source | finished product | Added protein* | Process | Mouthfeel #1 | Flavor |
| 1a | WPC80 | 2.88% | 2.35% | 720 g WPC80 added | Smooth, no | Slightly sweet |
| | | | | as each 25 Kg butter | evidence of | when |
| | | | | block was added to | powder. | compared to |
| | | | | the reworker. | | standard |
| | | | | | | butter. Clean |
| | | | | | | butter flavor. |
| 1b | WPI90 | 2.52% | 2.34% | 630 g WP190 added | Smooth, no | Flavor had a |
| | | | | as each 25 Kg butter | evidence of | milkier note |
| | | | | block was added to | powder. | when |
| | | | | the reworker. | | compared to |
| | | | | | | standard |
| | | | | | | butter. Clean |
| | | | | | | butter flavor. |
| 2a | WPI90 | 3.40% | 3.06% | 850 g added as each | Smooth, no | Flavor had a |
| | | | | 25 Kg butter block | evidence of | milkier note |
| | | | | was added to the | powder. | when |
| | | | | reworker. | | compared to |
| | | | | | | standard |
| | | | | | | butter. |
| 3a | WPC80 | 4.00% | 3.20% | 1,000 g added as | Smooth, no | Slightly sweet |
| | | | | each 25 Kg butter | evidence of | when |
| | | | | block was added to | powder. | compared to |
| | | | | the reworker. In this | | standard |
| | | | | trial all the butter | | butter. Clean |
| | | | | and protein were | | butter flavor. |
| | | | | added to the | | |
| | | | | reworker before the | | |
| | | | | butter was pumped | | |
| | | | | to the secondary | | |
| | | | | butter silo. There | | |
| | | | | was noticeable | | |
| | | | | protein powder left | | |
| | | | | in the reworker. | | |
| 3b | WPC80 | 4.00% | 3.20% | 1,000 g added as | Smooth, no | Slightly sweet |
| | | | | each 25 Kg butter | evidence of | when |
| | | | | block was added to | powder. | compared to |
| | | | | the reworker. | | standard |
| | | | | | | butter. Clean |
| | | | | | | butter flavor. |

In trial 1a, WPC80 was used and the finished product had 2.1000 protein or 0.30 g protein per 14 g serving. In trial 1b, WPI90 was used and the finished product had 1.86% or 0.26 g protein per 14 g serving.

In trial 2a, WPI90 was used and the finished product had 3.35% and 3.55% or an average of 3.45%, 0.483 g protein per 14 g serving.

In trial 3a and 3b, WPC80 was used and the finished product had 3.19% and 3.33% or an average of 3.26% protein (0.456 g protein per 14 g serving).

In Examples 1 and 2, WPC80 performed well producing a good flavor profile. With protein levels at 3.5%, 0.48 g protein per 14 g serving, the flavor was good.

The various characteristics of these embodiments may be used alone or be combined with one another. When they are combined, these characteristics may be combined as described above or differently, the invention not being limited to the specific combinations described in the present description. In particular, unless specified otherwise, a characteristic described in relation to an embodiment may be applied analogously to another embodiment.

What is claimed is:

1. A process for making protein enriched butter comprising the steps of
separating cream from raw milk,
churning the cream to produce butter and buttermilk,
removing the buttermilk from the butter,
adding protein to the butter,
mixing the butter and protein, and
forming the butter with the protein into desired form.

2. The process according to claim 1, wherein the protein is a milk protein, a milk protein concentrate, a milk protein isolate, whey protein concentrate, whey protein isolate, liquid concentrated protein, a plant protein, an animal protein or a combination thereof.

3. The process according to claim 1, further comprising pasteurizing the cream.

4. The process according to claim 3 wherein the pasteurizing is before the separating.

5. The process according to claim 3 wherein the adding protein is before the pasteurizing.

6. The process according to claim 1 wherein the protein is a whey protein concentrate.

7. The process according to claim 1 wherein the protein is a whey protein isolate.

8. The process according to claim 1 wherein the protein comprises 70-90% protein.

9. The process according to claim 1 further comprising adding one or more additives to one or more of the raw milk, cream, butter, and/or combinations thereof before the protein has been added.

10. The process according to claim 1 further comprising adding one or more additives to one or more of the raw milk, cream, butter, and/or combinations thereof after the protein has been added.

11. A process for making protein enriched butter comprising the steps of
separating cream from raw milk,
pasteurizing the cream,
adding protein to the cream,
churning the cream with the protein to produce butter and buttermilk,
removing the buttermilk from the butter, and
forming the butter into desired form.

12. A process for making protein enriched butter comprising the steps of
separating cream from raw milk,
pasteurizing the cream,
churning the cream to produce butter and buttermilk,
adding protein to the cream during the churning step,
removing the buttermilk from the butter, and
forming the butter into desired form.

13. A protein enriched butter produced by the process according to claim 1.

14. A process for making protein enriched margarine or spread comprising the steps of
preparing oil, fat or a combination thereof to remove unnecessary free fatty acids,
adding protein to the oil, fat or combination thereof, and
hydrogenating the oil, fat or combination thereof.

15. A process for making protein enriched margarine or spread comprising the steps of
adding protein to oil, fat or a combination thereof to create a mixture,
removing unnecessary free fatty acids from the mixture, and
hydrogenating the oil, fat or combination thereof in the mixture.

16. A process for making protein enriched margarine or spread comprising the steps of
preparing oil, fat or a combination thereof to remove unnecessary free fatty acids,
hydrogenating the oil, fat or combination thereof, and
adding protein to the hydrogenated oil, fat or combination thereof.

17. The process according to claim 14 wherein the protein is a milk protein, a milk protein concentrate, a milk protein isolate, whey protein concentrate, whey protein isolate, liquid concentrated protein, a plant protein, an animal protein or a combination thereof.

18. The process according to claim 15 wherein the protein is a milk protein, a milk protein concentrate, a milk protein isolate, whey protein concentrate, whey protein isolate, liquid concentrated protein, a plant protein, an animal protein or a combination thereof.

19. The process according to claim 16 wherein the protein is a milk protein, a milk protein concentrate, a milk protein isolate, whey protein concentrate, whey protein isolate, a plant protein, an animal protein or a combination thereof.

20. A protein enriched margarine or spread produced by the process according to claim 14.
